(19) United States
(12) Patent Application Publication
(10) Pub. No.: US 2015/0029222 A1
(43) Pub. Date: Jan. 29, 2015

(54) DYNAMICALLY CONFIGURING AN IMAGE PROCESSING FUNCTION

(71) Applicant: Klaus Michael Hofmann, Amsterdam (NL)

(72) Inventor: Klaus Michael Hofmann, Amsterdam (NL)

(73) Assignee: LAYAR B.V., Amsterdam (NL)

(21) Appl. No.: 14/361,592

(22) PCT Filed: Nov. 29, 2011
(86) PCT No.: PCT/EP2011/071305

§ 371 Date: Sep. 10, 2014

(51) Int. Cl. G06T 7/00; G06K 9/62; G06K 9/46; G06T 19/00

(52) U.S. Cl. CPC G06T 7/0044; G06T 19/006; G06K 9/6202; G06K 9/4609; G06T 2207/10004; G06T 2207/30204
USPC 345/633; 382/103

(57) ABSTRACT

Method and systems for dynamically configuring an image processing function into at least a first and second detection state on the basis of function parameters are described, wherein transitions between said detection states are determined by at least a first state transition condition and wherein said image processing function includes extracting features from an image frame, matching features with features associated with one or more target objects and estimating pose information on the basis of matched features and wherein method comprises: configuring said image processing function in a detection state on the basis of a first set of function parameter values; processing a first image frame in said first detection state; monitoring said image processing function for occurrence of said at least state transition condition; and, if said at least one state transition condition is met, configuring said image processing function in said second detection state.

### CROSS-REFERENCE TO RELATED APPLICATION

This application is a Section 371 National Stage Application of International Application PCT/EP2011/071305 filed Nov. 29, 2011 and published as WO2013/079098 A1 in English.

### BACKGROUND

The discussion below is merely provided for general background information and is not intended to be used as an aid in determining the scope of the claimed subject matter.

The disclosure generally relates to dynamically configuring an image processing function and, in particular, though not exclusively, to methods and systems for dynamically configuring an image processing function, a dynamically configurable image processing module, an augmented reality device comprising such module, an augmented reality system comprising such device and a computer program product using such method.

Due to the increasing capabilities of multimedia devices, mobile augmented reality (AR) applications are rapidly expanding. These AR applications allow enrichment (augmentation) of a real scene with additional content, which may be displayed to a user in the form of a graphical layer overlaying the real-world scenery in AR view thereby providing an “augmented reality” user-experience.

Presently, augmented reality platforms, such as the Layar Vision platform, are developed which allow an AR application to recognize an object (a target object) in an image frame and to render and display certain content together with the recognized object. In particular, an AR application may use vision-based object recognition processes (object recognition) in order to recognize whether a particular target object is present in an image frame generated by a camera in the multimedia device. Furthermore, the AR application may use a pose estimation process (pose estimation) to determine position and/or orientation (pose information) of the target object based on information in the image frame and sensor and/or camera parameters.

Examples of known image processing algorithms for object recognition and tracking are described in the article by Duy-Nguygen Ta et al. “SURFrac: Efficient Tracking and Continuous Object Recognition using local Feature Descriptors” IEEE Computer Society Conference on Computer Vision and Pattern Recognition (CVPR'09), Miami, Fla., Jun. 20-25, 2009. Object recognition may include extracting features from the image frame and matching these extracted features with reference features associated with objects stored in a database. By matching these reference features with the extracted features, the algorithm may determine that an object is “recognized”. Thereafter, the detected object may be subjected to a sequential estimation process (tracking) wherein the new state of the target object is estimated on the bases of new observables (e.g. a new image frame) and the previous state of the target object determined on the basis of a previous image frame. The aforementioned process may be repeated for each image frame at a sufficient fast rate, e.g. 15 to 30 frames per second, in order to ensure that the visual output on the display is not degraded by jitter or other types of flaws.

For typical AR applications, an image processing algorithm should be able to recognize multiple objects in a scene as fast as possible and track the thus recognized objects with sufficient accuracy in order provide the user a real AR user experience. Furthermore, in typical AR applications, the number of objects and the “complexity” of an object to be recognized may vary per scene. Hence, when user moves his AR device around a scene, the image processing algorithm should additionally be able to deal with disappearing recognized objects or new not yet recognized objects appearing in the image frames. All this information needs to be processed real-time by the AR application without or at least with minimum degradation to the AR user experience. The delay between the moment a target object appears in the image frame and the application adding AR content on top of that object should be hardly noticeable to a user. During that time nothing is happening on the screen, so a user doesn't know if the new object is augmented of not. With delays longer than approximately 1 second, users will move on (point the camera to a different object).

Known object recognition and tracking algorithms however, are less suitable for providing a true AR user experience. In particular, known image processing algorithms, use predetermined parameters associated with the recognition and tracking requiring a trade-off between speed of recognition and accuracy of tracking. Such implementation does not provide a scalable solution for both fast and accurate detection of multiple objects in image frames as for example required in AR applications.

Accordingly, there is a need to provide improved methods and systems that at least alleviate some of these problems.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the Background.

Hereinafter, embodiments of the invention will be described in further detail. It should be appreciated, however, that these embodiments may not be construed as limiting the scope of protection for the present invention. For instance, combinations of any of the embodiments and limitations are envisioned by the disclosure.

A first aspect of the invention is a method for dynamically configuring an image processing function into at least a first and second detection state on the basis of function parameters, wherein transitions between said first and second detection states are determined by at least a first state transition condition and wherein said image processing function includes extracting features from an image frame, matching extracted features with reference features associated with one or more target objects and estimating pose information on the basis of matched features, wherein said method may comprise: configuring said image processing function in a first detection state on the basis of a first set of function parameter values; processing a first image frame in said first detection state; monitoring said image processing function for occurrence of said at least first state transition condition; and, if said at least one state transition condition is met, configuring said image processing function in said second detection state on the basis of a second set of function parameter values for processing a second image frame in said second detection state.

Managing the function parameter values in accordance with a state machine allows each state in the state machine to be optimized for a specific image processing purpose. The state manager may initiate a state transition from a first state to a second state on the basis of certain predetermined state transition conditions, e.g. whether an object is detected in an image frame or whether a previously detected object associated with a previously processed image frame is no longer detectable in a current image frame. On the basis of such state transition conditions, the state manager may dynamically update one or more function parameter values thereby initiating a state transition in the image processing function. Optimization of each detection state for a certain predetermined imaging purpose provides improved scalability of the image processing function with regard to the number of target objects N. In particular, the use of the disclosed state machine manager allows improvement in the constant factor associated with the O(n) linear runtime complexity in the number of target objects N.

In an embodiment said first state transition condition may be: the detection of at least one target object in said first image frame, the detection of a predetermined number of objects in said first image frame, the absence in said first image frame of at least one previously recognized target object; and/or, the generation of pose information according to a predetermined accuracy and/or within a certain processing time.

In an embodiment said first detection state may be determined by a first set of function parameter values so that said image processing function is configured for fast detection of one or more objects in said first image frame.

In another embodiment said second detection state may be determined by a second set of function parameter values so that the image processing function is configured for accurate determination of pose information of at least one object in a second image frame, said object previously being detected by said image processing function in said first detection state.

In yet another embodiment said second detection state is determined by a second set of function parameter values so that the image processing function is configured for accurate determination of pose information of at least one object in a second image frame, said at least one object previously being detected in said first image frame by said image processing function in said first detection state; and, for fast detection of one or more objects in said second frame that were not previously detected in said first image frame by said image processing function in said first detection state.

In an embodiment said first and second set of parameter values may be configured such that in the first detection mode a smaller number of extracted features is used than in the second detection mode.

In a further embodiment said first and second set of parameter values may be configured such that in the first detection mode image frames of a lower resolution are used than the image frames used in the second detection mode, preferably said lower resolution images being a downscaled version of one or more images originating from an image sensor.

In yet another embodiment said first and second set of parameter values are configured such that in the first detection mode the maximum computation time and/or the (maximum) number of iterations for pose estimation is smaller than the computation time and/or (maximum) number of iterations spent on pose estimation in the second detection mode.

In an embodiment said first and second set of parameter values may be configured such that in the first detection mode a larger error margin and/or lower number of inlier data points for pose estimation is used than the error margin and/or number of inlier data points for pose estimation in said second detection mode.

In an embodiment said image processing function may be configurable in a further third state, wherein transitions between said first and third detection states are determined by at least a second transition condition, said method further comprising: monitoring said image processing function for occurrence of said at least second transition condition; and, if said at least second state transition condition is met, configuring said image processing function in said third detection state on the basis of said third set of function parameter values for processing a second image frame in said second detection state.

In an embodiment said processing of said first and second image frames may further comprise: providing a set of reference features, each set being associated with a target object; determining corresponding features pairs by matching said extracted features with said reference features; determining the detection of said target object on the basis of said corresponding features.

In an embodiment the image processing function may be part of an augmented reality device comprising an image sensor for generating image frames and a graphics generator for generating a graphical item associated with at least one detected target object on the basis of pose information.

In embodiment a state manager may be configured to configure said image processing function into at least said first or second detection state and to monitor said first state transition conditions, wherein function parameters values associated with said detection states and information associated with said first state transition condition is stored in memory.

In another embodiment function parameters may include parameters for determining and/or controlling: the number of features to be extracted from an image, the number or maximum number of iterations and/or processing time for processing features, at least one threshold value for deciding whether or not a certain condition in said image processing function is met, the resolution an image is to be processed in by said image processing function.

In a further aspect the invention may relate to a dynamically configurable image processing module comprising: a processor for executing a processing function configurable into at least a first and second detection state on the basis of function parameters, wherein said image processing function includes extracting features from an image frame, matching extracted features with reference features associated with one or more target objects and estimating pose information on the basis of matched features; a state manager for configuring said image processing function in one of detection states and for managing transitions between said detection states on the basis of least a first state transition condition, said state manager being configured to: configure said image processing function in a first detection state on the basis of a first set of function parameter values for processing a first image frame; monitor said image processing function for the occurrence of said at least first state transition condition; and, if said at least one state transition condition is met; and, configure said image processing function in said second detection state on the basis of a second set of function parameter values for processing a second image frame in said second detection state.

In another aspect, the invention may relate to an augmented reality device comprising: image sensor for generating image frames; a dynamically configurable image processing module as described above for detecting one or more target objects in an image frame and for generating pose information associated with at least one detected object; and, a graphics generator for generating a graphical item associated with said detected object on the basis of said pose information.

In yet another aspect, the invention may relate to an augmented reality system comprising: a feature database comprising reference features associated with one or more target objects, said one or more target objects being identified by object identifiers; a content database comprising one or more content items associated with said target objects, said one or more content items being stored together with one or more object identifiers; at least one augmented reality device as described above, wherein said augmented reality device is configured to: retrieve reference features from said feature database on the basis of one or more object identifiers; and, retrieve one or more content items associated with one or more objects on the basis of said object identifiers.

In one embodiment said augmented reality device in said augmented reality system may further comprise a communication module for accessing said content database and/or said feature database via a data communication network.

The invention may also be related to a computer program product, implemented on computer-readable non-transitory storage medium, the computer program product configured for, when run on a computer, executing the method according to any one of the method steps described above.

The disclosed embodiments will be further illustrated with reference to the attached drawings, which schematically show embodiments according to the invention. It will be understood that the invention is not in any way restricted to these specific embodiments.

### BRIEF DESCRIPTION OF THE DRAWINGS

Aspects of the invention will be explained in greater detail by reference to exemplary embodiments shown in the drawings, in which:

FIG. 1 depicts an exemplary augmented reality (AR) system according to one embodiment of the invention;

FIGS. 2A and 2B depict at least part of a device comprising a dynamically configurable image processing function according to one embodiment of the invention;

FIG. 3 depicts a flow diagram associated with a method for dynamically configuring an image processing function according to an embodiment of the invention;

FIG. 4A-4C depict schematics of an AR system according to an embodiment of the invention;

FIG. 5 depicts a dynamically configurable image processing function according to another embodiment of the invention;

FIG. 6 depicts a state machine descriptions of different detection states, according to one embodiments of the invention;

FIG. 7 depicts a state machine descriptions of different detection states, according to some embodiments of the invention;

FIG. 8 shows an exemplary set of features, according to one embodiment of the invention;

FIG. 9 shows an exemplary flow diagram, according to one embodiment of the invention;

FIG. 10A-B illustrates the known iterative sample consensus algorithm RANSAC.

### DETAILED DESCRIPTION

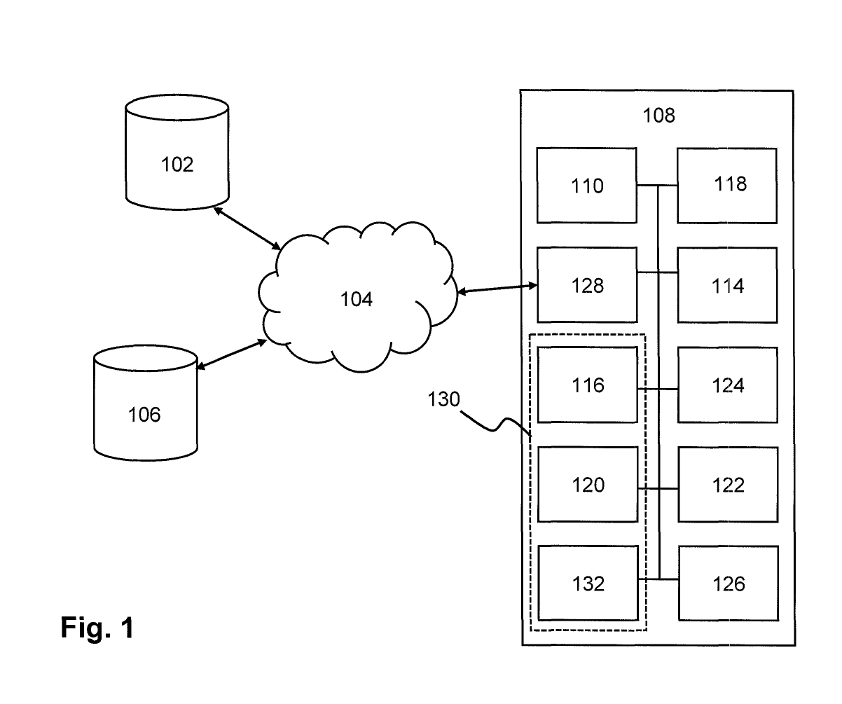

FIG. 1 depicts an exemplary augmented reality (AR) system according to one embodiment of the invention. In particular, the AR system depicted in FIG. 1 may comprise one or more (mobile) augmented reality (AR) devices 108 configured for executing an AR application 130. An AR device may be communicably connected via a data transport network 104, e.g. the Internet, to one or more servers 102,106 and/or databases which may be configured for storing and processing information which may be used by the image processing algorithms in the AR application.

For example, AR system may comprise at least a feature database 102 comprising feature information used by the AR application during the process of recognizing and determining pose information associated with one or more objects in image frames. Further, AR system may comprise a content database 106 comprising content items, which may be retrieved by an AR application for augmenting an object recognized by the AR application. The AR device may comprise a plurality of components, modules and/or parts that may be communicably connected together by a communication bus. In some embodiments, those sub-parts of the AR device may be implemented in a distributed fashion (e.g., separated as different parts of an augmented reality system).

AR device may comprise a processor 110 for performing computations for carrying the functions of device. In some embodiments, the processor 110 includes a graphics processing unit specialized for rendering and generating computer-generated graphics. Preferably, processor 110 is configured to communicate, via a communication bus with other components of device.

The AR device may comprise a digital imaging part 114, e.g. an image sensor such as an active pixel sensor or a CCD, for capturing images of the real world. The image sensor 114 may generate a stream of image frames, which may be stored in an image frame buffer in memory 124 which is accessible by the AR application 130. Exposure parameters associated with image sensor 114 (e.g., shutter speed, aperture, ISO) may be adjusted manually or on the basis of an exposure function.

Image frames rendered by the image sensor 114 and buffered in the memory may be displayed by a display 122 which may be implemented as a light emitting display or any other any suitable output device for presentation information in visual form. In one embodiment, the display may include a projection-based display 122 system, e.g. projection glasses or a projection system for projection of visual information onto real world objects. In some other embodiments, the display 122 may include a head-mounted display system configured for optically information into the eyes of a user through a virtual retinal display.

The device may utilize a user interface (UI) 118 which may comprise an input part and an output part for allowing a user to interact with the device. The user interface 118 may be configured as a graphical user interface (GUI) on the basis of e.g. a touch-sensitive display. In that case, the UI 118 may be part of the display 122. Other user interfaces may include a keypad, touch screen, microphone, mouse, keyboard, tactile glove, motion sensor or motion sensitive camera, light-sensitive device, camera, depth or range cameras, or any suitable user input devices. Output part 118 may include visual output, as well as provide other output such as audio output, haptic output (e.g., vibration, heat), or any other suitable sensory output.

The AR device 108 may further comprise an Operating System (OS) 126 for managing the resources of the device as well as the data and information transmission between the various components of the device. Application Programming Interfaces (APIs) associated with the OS 126 may allow application programs to access services offered by the OS. For example, one API may be configured for setting up wired or wireless connections to data transport network 104. Mobile service applications in communication module 128 may be executed enabling the AR application to access servers and/or databases connected to the data network 104.

The AR application 130 may be at least partially implemented as a software program. Alternatively and/or additionally AR application 130 may be at least partially implemented in dedicated and specialized hardware processor. The implementation of AR application 130 may be a computer program product, stored in non-transitory storage medium, when executed on processor 110, is configured to provide an augmented reality experience to the user. The AR application 130 may further comprise an image processing function 116 and a graphics generating function 120 for providing computer-generated graphics.

The image processing function 116 may comprise one or more algorithms for processing image frames generated by the image sensor 114. In particular, the image processing function may include: extracting features from an image frame, retrieving a number of reference features associated with at least one target object (i.e. an particular object to be recognized in the image frames) and matching the extracted features with the reference features. If a sufficient correspondence with a particular target object is detected, a pose estimation is performed on thus detected target object.

As the image processing function is configured to detect the object target in every frame, it effectively enables an accurate “tracking-as-detection” process wherein, each object is re-detected in each image frame. This way errors in the detection and pose information are minimized. Based on the determined pose information, the object may be tracked (i.e. followed) in subsequent image frames. Hence, for the purpose of this application, the term tracking refers to following an object in subsequent image frames by re-detecting the object in subsequent image frames.

The AR application 130 may be configured to execute the image processing function in different modes, hereafter referred to as detection modes or states. In one detection mode (a first state), the image processing function may be configured for fast detection of objects in an image frame on the basis of a number of pre-loaded target objects. In another detection mode (a second state), the image processing function may be configured for accurate determination of pose information for at least some of the previously recognized target objects.

Hence, as will be described hereunder in more detail, the image processing function may be configured in accordance with a particular detection state, wherein the configuration may be realized on the basis of a particular set of function parameters i.e. parameters used for configuring the image processing function, e.g. the number data used for a particular process in the image processing function such as the number of extracted and reference features used by the extraction and matching function, the (maximum) number of iterations or the (maximum) amount of runtime which the image processing function may use for meeting a certain condition (e.g. matching features) or determining certain information (e.g. pose information), (threshold) values for meeting a certain condition (e.g. a matching condition), etc.

To that end, a (detection) state manager 132 associated with the image processing function may keep track of the particular detection state the image processing function is in. Furthermore, the state manager 132 may monitor certain conditions associated with a state transition from a first to a second detection state. If such condition is met, the state manager 132 may initiate a transition of a first state to a second state by adjusting the function parameters used by the processing algorithm. The state manager 132 may store state information, e.g. information determining which state the AR device is in, conditions associated with state transitions and function parameters associated with the different detection states in a memory.

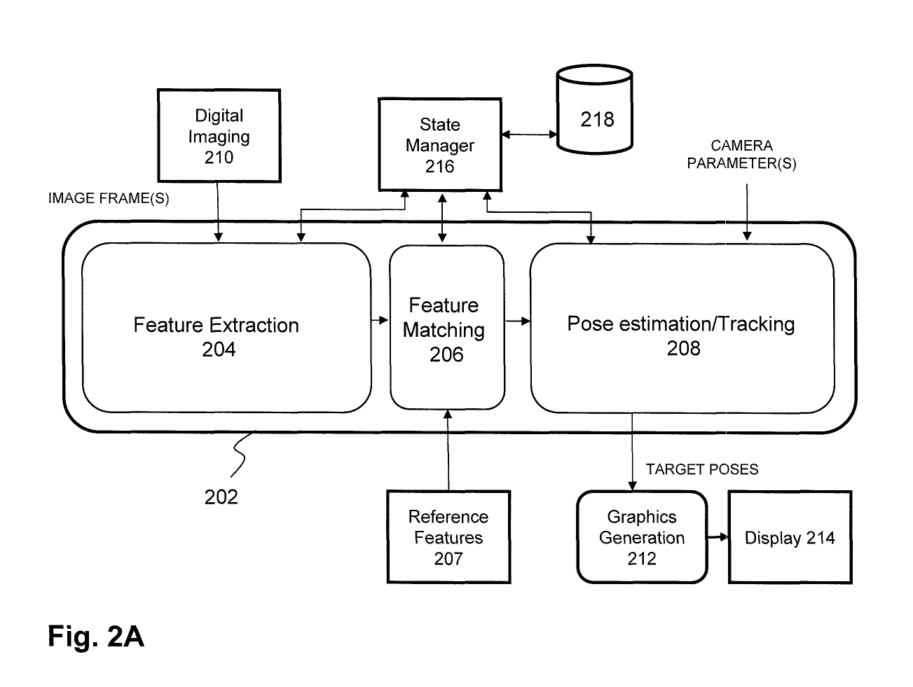

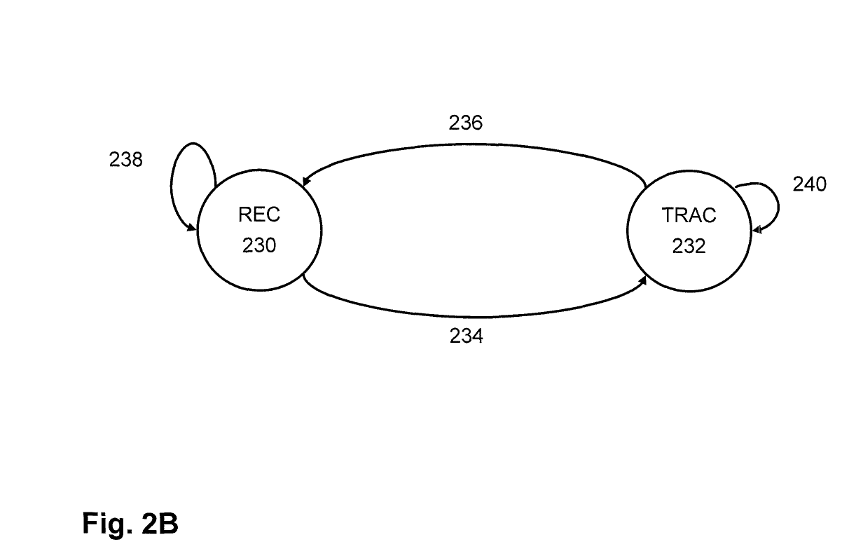

FIGS. 2A and 2B depict at least part of a device comprising a dynamically configurable image processing function according to one embodiment of the invention. In particular, FIG. 2A schematically depicts an image processing function 202 connected to a detection state manager 216. The image processing function 202 may comprise a feature extraction function 204, a feature matching function 206 and a pose estimation/tracking function 208.

The feature extraction function 206 may receive one or more image frames from the image sensor 210. This function may then extract suitable features (i.e. specific structures in an image such as edges or corners) from the image and store these extracted features in a memory. Features may be stored in the form of a specific data structure usually referred to as a feature descriptor. Various known feature descriptor formats, including SIFT (Scale-invariant feature transform), SURF (Speeded Up Robust Features), HIP (Histogrammed Intensity Patches), BRIEF (Binary Robust Independent Elementary Features), ORB (Oriented-BRIEF), Shape Context, etc., may be used.

A feature descriptor may include at least a location in the image from which the feature is extracted, descriptor data, and optionally, a quality score. On the basis of the quality score, features may be stored in an ordered list. For example, if extraction is performed on the basis of corner information (“cornerness”) of structure in an image frame, the list may be sorted in accordance to a measure based on this corner information.

Then, after extracting features from the image frame, a feature matching function 206 may be executed. The feature matching function 206 may receive reference features 207 associated with one or more target objects. These reference features may be requested from a remote feature database. Alternatively, at least part of the reference features may be pre-loaded or pre-provisioned in a memory of the AR device. Thereafter, the extracted features may be matched with the reference features of each target object.

The implementation of the matching process may depend on the type of feature descriptor used. For example, matching may be computed on the basis of the Euclidean distance between two vectors, the Hamming distance between two bitmasks, etc.

As a result of the matching process, pairs of matched extracted/reference features, i.e. corresponding feature pairs, may be generated wherein an error score may be assigned to each pair. A threshold parameter associated with the error score may be used in order to determine which matched pairs are considered to be successful corresponding feature pairs. The result of this process is a list of corresponding feature pairs, i.e. a list of pairs of extracted and reference features having an error score below the threshold parameter.

On the basis of the list of corresponding feature pairs, a pose estimation function 208 may calculate an estimate of the pose parameter of the object with reference to the AR device which can be determined on the basis of the intrinsic camera parameters, including the focal length and the resolution of the image sensor 210. The intrinsic parameters relate to the parameters used in the well-known 3×4 homogeneous camera projection matrix. Pose estimation may be done by a fitting processes wherein a model of the target object is fitted to the observed (extracted) features using e.g. function optimization. As the list of corresponding feature pairs may likely contain pairs, which negatively influence the estimation process (so-called “outliers”), the model fitting may comprise a process wherein outliers are identified and excluded from the set of corresponding features pairs. The resulting feature set (the so-called “inlier” set) may then be used in order to perform the fitting process.

The pose information generated by the pose estimation function 208 may then be used by the graphics generation function 212 which uses the pose information to transform (i.e. scaling, reshaping and/or rotating) a predetermined content item so that it may be displayed on display 214 together with the detected object in the image frame.

The above described process executed by the feature extraction 204, feature matching 206 and pose estimation function 208 is repeated for substantially each image frame. Hence, when trying to recognize an object in a frame from N target objects, the amount of time needed grows linearly with N. Hence, when trying to detect multiple or, in some cases, all objects in each frame, the required time using this approach may become problematic for even moderately large N.

Hence, for that reason a detection state manager 216 manages the image processing function by configuring the functions with different sets of function parameter values. These parameter values may be stored as state information in a memory 218. Each set of function parameter values may be associated with a different state of the image processing function 202, wherein different states may be optimized for a specific image processing purpose such as fast recognition of an object out of a large set of pre-loaded target objects or accurately estimating pose information (a smaller set of) previously recognized objects.

In one embodiment, the state manager 216 may be configured to configure the image processing function 202 in different detection states. FIG. 2B depicts a state machine description of at least two detection states associated with the image processing function 202 according to an embodiment of the invention. In particular, FIG. 2B depicts a first detection state 230 (the recognition state REC) and a second detection state 232 (the tracking state TRAC).

In the first, recognition state 230, the state manager 216 may configure the image processing function 202 on the basis of function parameter values such that detection of a target that is present in an image is likely to be successful in the least amount of time. In other words, this detection state 230 allows the imaging function to be optimized towards speed. Furthermore, the function parameter values may be set such that the image processing function 202 is configured to detect all or at least a large number of retrieved or (pre)loaded target objects. This way, initially, the feature matching stage is performed for all or at least a large number of available target objects. Hence, in the recognition state 230, the image processing function may be configured to use a relatively small number of extracted features (between approximately 50 to 150 features). Moreover, a maximum computation time for pose estimation is set to a relatively small amount (between approximately 5 to 10 ms spent in the (robust) estimation process; or, alternatively, approximately 20-50 (robust) estimation iterations).

In contrast, in the tracking state 232, the state manager 216 may configure the imaging processing function 202 on the basis of function parameter values such that detection of a target object that is present in the image frame may be performed with high precision. In other words, the detection state configures the imaging function to be optimized towards accuracy. Furthermore, the function parameter values may be set such that the imaging processing function 202 is able to detect previously detected target objects (i.e. target objects in a preceding image frame detected in the recognition state) 230.

Furthermore, in an embodiment, the image processing function 202 in the tracking state 232 may be further configured such that no other target objects can be detected. In general, in the tracking state 232, the image processing function 202 may be configured to use a relatively large number of extracted features (between approximately 150 and 500 features). Moreover, maximum computation time for pose estimation is not set or limited to a relatively large amount of time (between approximately 20 to 30 ms spent in the (robust) estimation process; or, alternatively, approximately 50-500 (robust) estimation iterations).

The detection state manager 216 may monitor the process executed by the image processing function 202 and check whether certain state transition conditions are met. For example, upon initialization, the state manager 216 may set the image processing function 202 in the recognition state 230 in order to allow detection of objects in an image frame. If no objects are detected, the state manager 216 may determine the image processing function 202 to stay in the recognition state 230 for processing subsequent image frames until at least one object is detected. Hence, in that case the image processing function 202 stays in the recognition state 230 for each image frame until an object is recognized (denoted by arrow 238). Alternatively, if at least one object is detected, the state manager 216 may determine that a state transition condition is met and initiate a state transition 236 to the tracking state 232 by provisioning the image processing function 202 with another set of function parameter values. Switching to the tracking state may include at least one adjustment in a function parameter value used by the image processing function 202.

In the tracking state 232, the image processing function 202 may execute an algorithm such that accurate pose estimation on the basis of detected objects in a previous image frame is enabled. The tracking mode may be maintained by the state manager 216 for each subsequent image frame as long as the recognized object is present in the image frames (denoted by arrow 240). If the object is no longer in the image frame or if no pose estimation can be determined for other reasons, the state manager 216 may initiate a state transition 234 back to the recognition state 230.

In some embodiments, output is generated and provided to the user during a state transition in order to provide feedback to the user. Such feedback is useful for letting the user know that he or she should stop moving the camera about the real world and focus or look at a particular object.

Hence, from the above it follows that the state manager 216 allows an image processing function 202 to adapt the function parameter values in accordance with a state machine wherein each state in the state machine may be optimized for a specific image processing purpose.

The state manager 216 may initiate a state transition from a first state to a second state on the basis of certain predetermined state transition conditions, e.g. whether an object is detected in an image frame or whether a previously detected object associated with a previously processed image frame is no longer detectable in a current image frame. On the basis of such state transition conditions, the state manager 216 may dynamically update one or more function parameter values thereby initiating a state transition in the image processing function 202. Each state is optimized for a certain predetermined imaging purpose thereby providing improved scalability of the image processing function 202 with regard to the number of target objects N. In particular, the use of the disclosed state machine manager allows improvement in the constant factor associated with the O(n) linear runtime complexity in the number of target objects N.

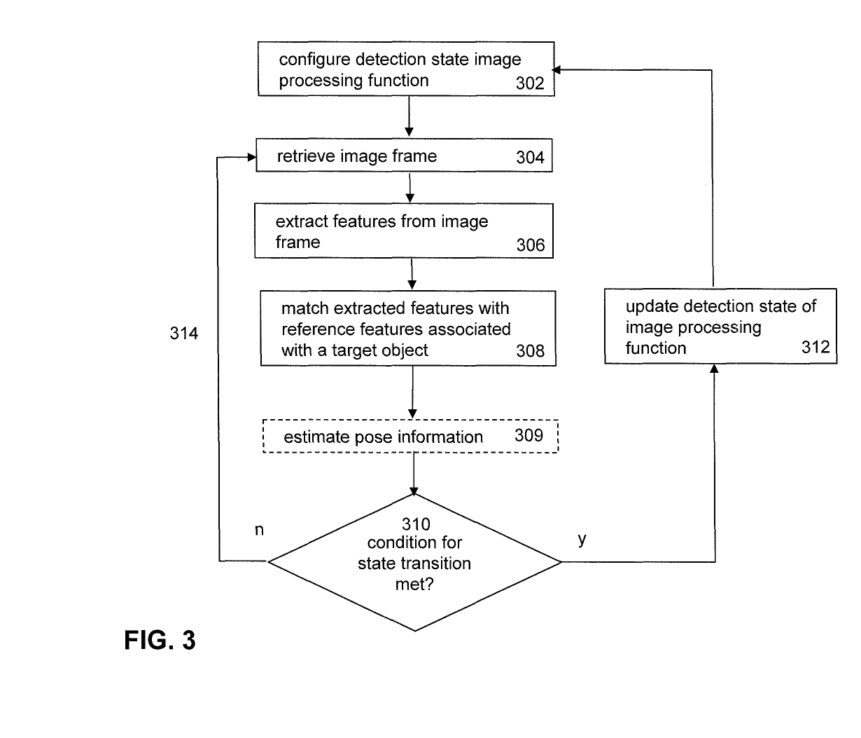

FIG. 3 depicts a flow diagram associated with a method for dynamically configuring an image processing function 202 according to an embodiment of the invention. In particular, FIG. 3 depicts a flow diagram associated with a method for dynamically configuring an image processing function 202 on the basis of a state machine comprising two or more detection states and state transitions between those detection states. In one embodiment, the state machine may be configured according to the state machine description as depicted in FIG. 2B.

The process may start with the state manager 216 configuring an image processing function 202 for recognizing and estimating pose information of at least one object in an image frame in a first detection state on the basis of a particular set of function parameter values (step 302). The image processing function 202 may comprise a feature extraction function 204, a feature matching function 206 and a tracking/pose estimation function 208 as described with reference to FIG. 2A. Further, in one embodiment, the image processing function 202 may be part of an AR application as described with reference to FIG. 1.

The function parameters may include image-processing parameters such as the number of extracted features, the threshold for determining whether corresponding feature pairs are considered to be successful corresponding feature pairs, minimum number of corresponding feature pairs, etc.

If the first detection state relates to a recognition state REC 230 for quickly detecting objects in an image, a relatively small number of extracted features may be used for processing an image frame. Alternatively, if first detection state relates to a tracking state TRAC 232, more extracted features may be used in processing an image frame when compared to the number of extracted features in the recognition state REC 230. A more detailed discussion of the function parameters, which may be used to configure the image processing function 202 in a particular detection state, is provided hereunder. In one embodiment, function parameters may also include parameters “external” to the image processing function 202 such as camera exposure, frame rate, etc.

After the configuration of the image processing function 202, a first image frame may be retrieved for processing (step 304). The feature extraction function 204 associated with the image processing function 202 may extract a number of features (step 306) on the basis of a feature extraction algorithm as e.g. described with reference to FIG. 2A.

A feature matching function 206 may subsequently match at least part of the extracted features on the basis of reference features associated with one or more target objects, which—in one embodiment—may be retrieved from a feature database in the network (step 308). The matching process may further include the determination of a list of corresponding feature pairs, which may be used to determine whether sufficient correspondence is determined in order to determine that an object is detected.

In a further, optional step 309, the corresponding feature pairs are used for estimating pose information 208. Based on the result of the matching step 308 and, optionally, the pose estimation step, the state manager 216 may determine whether the result of the image processing of an image frame may give rise to a transition in the detection state of the image processing function 202 (step 310). If such state transition condition is met, the state manager 216 may initiate an update of the detection state 230 (step 312) by changing at least one of the function parameter values configuring the image processing function 202. The process flow may then return to step 302, wherein the detection state 230 of the image processing function 202 for the subsequent image frame is configured on the basis of the updated detection state as determined in step 312.

Conditions for initiating a transition in a detection state 230 may include: detecting at least one object in an image frame during matching, a previously detected object associated with a previously processed image frame is no longer detectable in a current image frame, or in case the pose estimation step is also included in a state transition condition, determining a valid pose estimation. If none of the conditions for a state transition are met, the image processing function 202 may start processing a further image frame in the same detection state 230 as the previous one (step 314).

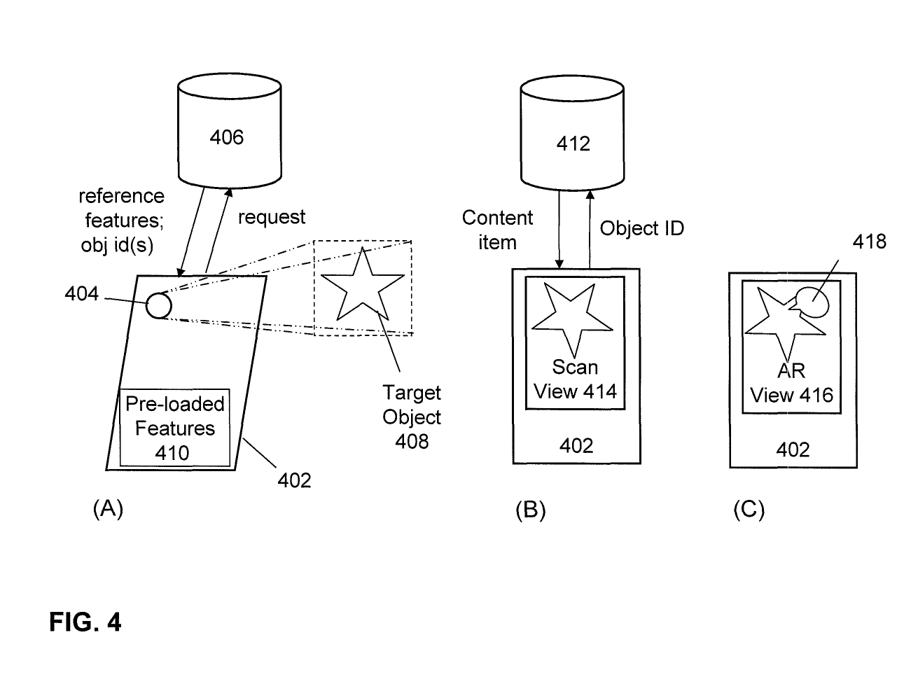

FIG. 4 depicts a schematic of an AR system according to an embodiment of the invention. In particular, FIG. 4 depicts a schematic of the functioning of an AR system comprising an AR device with an AR application as described with reference to FIGS. 2 and 3.

FIG. 4A depicts an AR device 402 as described with reference to FIG. 1. The AR device 402 may be configured to contact a feature database 406 in order to retrieve sets of reference features wherein each set is associated with a certain object, which may be identified by an object identifier ID. Reference features may be requested on the basis of location information of the AR device (using e.g. GPS location) or certain input information e.g. user input, user profile, etc. Alternatively and/or in addition AR device 402 may be pre-configured with sets of reference features 410.

For instance, AR device 402 may contact a reference feature database associated with a magazine publisher to sets of reference features associated with a plurality of magazine pages in a particular issue of a magazine. Each page of the magazine may be associated with at least one of: a set of reference features, metadata, thumbnail, and an object identifier. Metadata may be used to describe the magazine or provide supplemental information about the target object. An object identifier may enable retrieval of data or content items associated with that target object from content database 412 (FIG. 4B). The AR device 402 may comprise a camera 404 for capturing images of the real world scenery comprising a target object 408.

FIG. 4B schematically depicts AR device 402 wherein captured image frames are shown as scan view 414 on the display of the AR device 402. As a user is moving about the real world with the AR device 402, pointing the camera at various objects, the AR application may execute the image processing function 202 in order to determine if a target object can be detected in the image frames. Specifically, the image frames are each processed by the image processing function 202, including: feature extraction, matching of extracted features with the reference features and, if a match is found, estimating pose information associated with the detected object. Upon detection of at least one object in an image frame, a state manager 216 in the AR application 130 may initiate a state transition of the image processing function 202 from a first, recognition state 230 optimized for fast detection of an object in an image frame to a second, tracking state 232 for accurately determining pose information associated with a previously detected object.

In one embodiment, upon detecting an object in an image frame, the image processing function 202 may associate an object identifier to the detected object. The object identifier may be used for retrieving one or more content items from a content database 412.

Upon detecting a target object, pose information (i.e. position and/or orientation information) associated with the target object may be estimated. The thus estimated pose information may be used by a graphics generating function to scale, transform and/or rotate a content item associated with the tracked target object. The content may then displayed to a user as graphical overlay 418 superimposed on image frames to form augmented reality view 416. As the state manager 216 allows the image processing function 202 in the AR application 130 to dynamically switch between different detection states, each being optimized for a specific image processing goal, e.g. fast object detection, accurate pose detection, etc., the AR application 130 allows detection and estimating pose information of multiple objects in image frames without endangering the AR user experience.

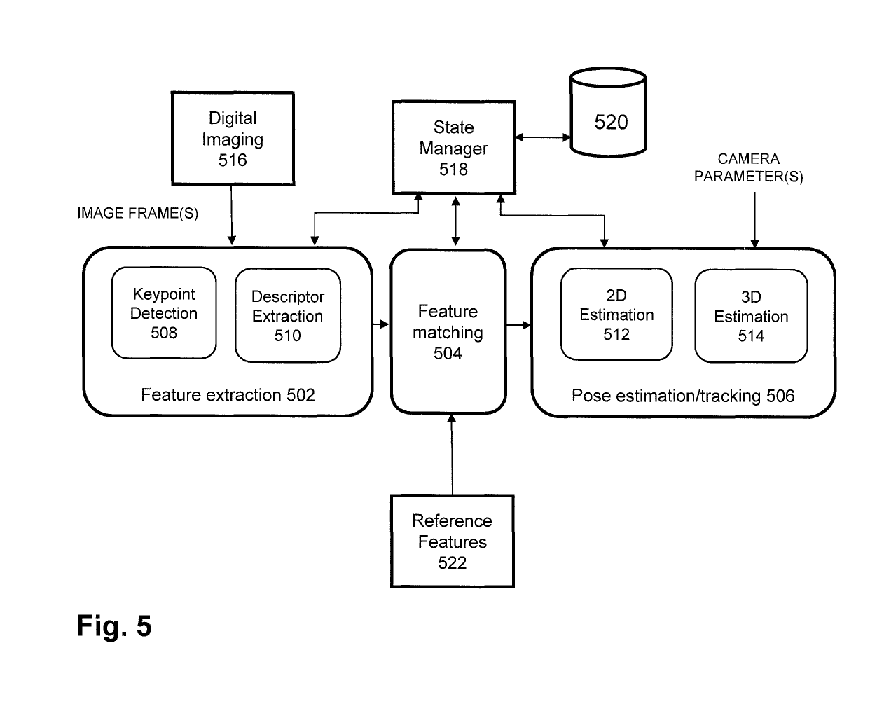

FIG. 5 depicts a dynamically configurable image processing function 202 according to another embodiment of the invention. In particular, FIG. 5 depicts an image processing function 202 comprising a feature extraction function 502, a feature matching function 504 and a pose estimation function 506 similar to the one described with reference to FIG. 2A. In this particular embodiment however, the feature extraction function 502 and pose estimation function 506 may comprise further (sub)functions. Hereunder, these functions as well as their parameters are described in more detail.

Feature extraction function 502 may extract features (e.g., specific structures in the image frame) from an image frame. Such extracted features may also be referred to as “candidate features”. The candidate features may be stored in a data structure such as a list, an array or a tree structure. As already discussed features may have a certain data structure usually referred to as a feature descriptor. A feature descriptor is a representation of certain structures (e.g., points an/or edges) in an image frame that enables the process of object recognition (e.g. matching extracted features with reference features) to occur in an efficient manner. Features may be extracted using algorithms such as: Scale-Invariant Feature Transform (SIFT), Speeded Up Robust Features (SURF), Binary Robust Independent Elementary Features (BRIEF), Gradient Location and Orientation Histogram (GLOH), Histogram of Oriented Gradients (HOG), Local Energy based Shape Histogram (LESH), Shape Context, etc.

In order to facilitate the matching process (pre-loaded or pre-defined) reference features associated with a target object are preferably extracted using the same or a substantially similar feature extraction algorithm on a reference image of the target object.

Feature extraction function 502 may include two sub-functions, a keypoint detection function 508 and descriptor extraction function 510. The keypoint detection function 508 may identify feature points (i.e., 2D pixel coordinates) that are distinctive or interesting for further analysis. For example, keypoint detection function 508 may perform corner detection. Example corner detection algorithms include: Harris operator, Shi and Tomasi, Level curve curvature, Smallest Univalue Segment Assimilating Nucleus (SUSAN), Features from Accelerated Segment Test (FAST), etc. Each detected keypoint includes a 2D pixel position and preferably a quality score. In one embodiment, keypoint detection function 508 may use Keypoint parameter K for adjusting the number of keypoints being taken into account for further processing (e.g., the K best ranking keypoints based on quality scores). Keypoint parameter K generally defines the maximum number of keypoints from which features are extracted, e.g., by descriptor extraction module 510.

Keypoint parameter K may affect object recognition and estimation of pose information in different ways. In general, object recognition (i.e. detecting presence or non-presence of an object) is likely to work on a smaller number of extracted features. In contrast, tracking (i.e. estimating the pose of a target) is more likely to be more accurate using a larger number of features. If the objective is to optimize object recognition, keypoint parameter K may be set to have a lower value than if the objective is to optimize pose estimation. A lower value for K may decrease accuracy for pose estimation. On the other hand a higher value for K may increase accuracy for pose estimation. Thus, if at least one target object has already been recognized, the (reduced) set of target objects may be tracked using an image processing function comprising an accurate pose estimation procedure (e.g., by setting a higher value for K). When optimizing for object recognition, keypoint parameter K may be selected in a range between 50 and 150. When optimizing for pose estimation, keypoint parameter K may be selected between 150 and 500. The setting may also depend on values set for other function parameters.

Descriptor extraction function 510 may be configured to extract feature descriptors in a region surrounding each of the keypoints under consideration (i.e., each of the K number of keypoints), using image frame(s) from an image sensor 516 as input. Feature (descriptor) extraction may involve extraction and, optionally, normalization of (grayscale and/or color) values associated with a region in the image (an image patch). The region size and shape of the image patch may be determined based on external parameters or based on computation of a patch orientation (which itself is dependent on the image data). Extracted values may pass through one or more functions, e.g. derivative filters, to extract the desired properties. Suitable feature-based descriptors include SIFT (Scale-invariant feature transform), SURF (Speeded Up Robust Feature), GLOH (Gradient Location and Orientation Histogram), HOG (Histogram of oriented gradients), etc.

In some embodiments, at least one of keypoint detection function 508 and descriptor extraction function 510 may use a parameter for adjusting whether multiple input image scales are to be used.

Feature extraction may be performed on the original input image frame, as well as one or more downscaled versions of the image frame. If the feature descriptor is not of a type that is scale invariant, performing keypoint detection and/or descriptor extraction over multiple input image scales may improve how discriminate the extracted features are. The increased accuracy of feature matching and/or pose estimation may be at a cost of longer computation time caused by performing the method over multiple image scales.

Therefore, if at least one (candidate) target object has been found, the multiscale parameter MSC may be set to multiscale such that feature extraction is executed over multiple image scales (i.e., on a reduced set of candidate targets). This way pose estimation may be optimized for accuracy on those (reduced number of) candidate target objects. MSC may be a Boolean flag having two values. Alternatively, multiscale parameter MSC be a variable that configures how many scales should be used (e.g., 1, 2, 3, and so on).

In some embodiments, the image resolution of the image frame being processed may be adjusted by a resolution parameter RES. RES may be a value pair for adjusting the resolution of the input image frame in terms of pixels (e.g., 400×240). The resolution parameter may be adjusted to increase accuracy or lower accuracy of the system. In certain situations, this parameter may be adjusted based on the hardware configuration of the AR device and/or current processing resources available on the AR device.

After feature extraction, feature matching module 504 may take the extracted candidate features and determine how closely the candidate features matches a given set of reference features (e.g., from pre-loaded features) for a particular target object of interest. The determination may provide a score which represents how well the candidate features matches the set of reference features (e.g., correspondence score) or how poorly the candidate features matches the set of reference features (e.g., error score). Depending on the type of feature used, the feature matching process may vary. One feature matching process may be computed by taking the Euclidean distance of two vectors. Another feature matching process may be computed using the Hamming distance of two bitmasks.

In one embodiment, for each candidate feature extracted from the input data, each reference feature (of each target object) is assigned an error score by matching the two features. If there are Q number of candidate features, and R number of reference features, there may be up to Q×R number of error scores calculated/generated. A threshold may be applied on this error score to determine which pair of candidate and reference features is considered a candidate correspondence (referred to as a “corresponding feature”) for a particular target object.

When a target object has at least a minimum number of corresponding features between the target object's reference features and the candidate features, the image processing function may determine to further process the target object (i.e., estimating pose information). Such target object may be referred to as a candidate target object (or in short a candidate target). The matching process may be repeated for each of the pre-loaded sets of reference features. For example, all target objects are cycled through to determine which one(s) may be a candidate target having sufficient number of corresponding features from the matching process. The result of this feature matching step includes a list of at least one candidate target and the corresponding features associated with each of the candidate target(s) in the list.

Candidate features that were not considered corresponding features may be effectively discarded and not passed on for further processing. It may be possible that no candidate targets are found (e.g., not enough correspondences are found). In that case, the procedure halts for that particular image frame and a next image frame from the digital imaging part is processed at the feature extraction stage (e.g., feature extraction function 502).

Feature matching function 504 may include parameter(s) that are adjustable based on the results of image processing from the last frame. One parameter includes threshold parameter T_match which is used to determine whether an error score between a pair of features, i.e. candidate feature (extracted by feature extraction function 502) and a reference feature, is sufficiently good enough to be considered a corresponding feature pair. Threshold parameter T_match may determine how high or low the threshold should be applied to an error or correspondence score associated with a pair of candidate features and reference features.

For instance, the error score or correspondence score may be compared with the threshold to determine whether a candidate feature matches closely enough to a reference feature in order to qualify as a corresponding feature (e.g., requiring the error score to have a value below the threshold or requiring the correspondence score to have a value above the threshold).

Correspondence parameter C may be used by feature matching function 504 for adjusting a minimum number of corresponding features required for a candidate target (and its associated corresponding features) to enter pose estimation module 506. In general, if the method is optimized for object recognition, correspondence parameter C may be set at a lower number such that less corresponding features are required to enter pose estimation step. If the method is optimized for pose estimation, correspondence parameter C may be set at a higher number such that more corresponding feature pairs for a particular target object is required to enter the tracking state (i.e., to be considered as a candidate target).

There may be some degree of correlation between C and K. If fewer keypoints K are used for feature extraction, fewer correspondences can potentially be found. Hence, C may be lowered when optimizing for recognition because K is also lowered when optimizing for recognition (as opposed to when optimizing for pose estimation). However, if C is set too low, there is a chance that too many candidate targets enter the pose estimation stage. If C is set too high, too few candidate targets might enter the pose estimation stage.

Given the list of candidate target(s) (e.g., represented by the respective object identifier(s)) and the associated corresponding feature pairs for each candidate target(s), the pose estimation function 506 may estimate pose information for each of those candidate target objects. At the end of the pose estimation process, pose information for at least one of the candidate target(s) is produced. It may be possible that pose information cannot be determined for any of the candidate targets. In that case, the procedure halts and a next image frame from the digital imaging part is processed at the feature extraction stage (e.g., feature extraction function 502). If determining the pose information was successful, the pose information may then be provided to a graphics generator for rendering an augmented reality view to the user via a display.

Corresponding feature pairs may be used in pose estimation function 506 for estimating pose information. Furthermore, intrinsic camera parameters may be used to aid in pose estimation. In general, pose estimation may be performed by iteratively fitting a (test) model to the observed data (e.g., the corresponding feature pairs). For each candidate target found, pose estimation function 506 may separately apply a robust iterative pose estimation process on the corresponding feature pairs associated with the candidate target. The iterative procedure (e.g., a sample consensus method) may eliminate outliers with a bad fit such that a sufficiently good model with sufficient number of inliers is produced, and those inliers are then further processed for the purposes of pose estimation (i.e., pose/orientation estimation).

For instance, a robust iterative model fitting process may first determine a two-dimensional position model of the object projected on the image plane and a set of inliers that sufficiently fit said model (a projective transformation). This process may be referred to as two-dimensional homography. The result of the robust iterative process includes a set of sufficiently good inliers, and three-dimensional pose estimation is applied to that set of inliers using the estimated projective transformation (i.e., outliers are effectively eliminated from further processing because outliers may negatively affect orientation estimation).

In some embodiments, pose estimation function 506 may directly estimate the three-dimensional pose in one iteration of the robust iterative process (without first performing two-dimensional pose estimation). This embodiment may be used for the estimation of non-planar targets. While the above describes an iterative process as being used for the pose estimation step, other robust estimation methods may also be used, such as Least Median of Squares (LMedS), M-estimators, etc.

Given the candidate targets determined from feature matching function 504, 2D estimation function 512 may estimate a 2D homography matrix on the basis of the corresponding feature pairs. The 2D homography matrix describes a projective mapping between the candidate feature positions and the reference feature positions. Some observations (i.e., some corresponding features for a particular target object) may negatively affect modelling performed in 3D estimation function 514. As such, some observations may be eliminated from further processing, if those observations do not fit well with the model estimated in the 2D estimation function 512.

Accordingly, 2D homography matrix may be estimated robustly in 2D estimation module 512 by using an iterative sample consensus method such as Random Sample Consensus (RANSAC) method, Progressive Sample Consensus (PROSAC), Deterministic Sample Consensus (DESAC), Bayesian Sample Consensus (BaySAC), etc. The iterative sample consensus method enables a sufficiently good model to be determined at 2D estimation function 512, wherein the model comprises a set of inliers. Outliers that do not fit the model are then effectively eliminated for further processing (i.e., not used in 3D estimation module 514. While the above lists sample consensus methods as used for the pose estimation step, other robust estimation methods may also be used, such as Least Median of Squares (LMedS), M-estimators, etc.

In general, the iterative sample consensus method (separately applied to each candidate target and the associated corresponding features) may involve the following steps at each iteration, preferably until a termination criterion is satisfied (i.e., sufficiently good model has been found) and/or maximum number of iterations reached:
choose a subset of corresponding feature pairs (preferably a minimum number of features is chosen as the subset, either by a random and/or a deterministic step, depending on the iterative sample consensus method);
estimate a test (position) model fitted onto the subset of corresponding feature pairs,
test how well the test model fits with the corresponding features, preferably involving an error threshold to determine how well each corresponding feature (e.g., outside the subset) fits with the test model on the basis of an error, said error, in the case of homography estimation may include a transfer error, reprojection error, Sampson error, etc., and
if the test model is better than all previously estimated test models, store parameters of this test model.

Some methods, e.g., PROSAC, take additional information into account, such as the ordering of the corresponding feature pairs by match error score. For the case of planar targets, the output of 2D estimation module 512 may include a 2D homography matrix representing a 2D position estimate as well as a set of inliers that fit this 2D position estimate. More generally, pose estimation function 506 may be used in conjunction with any suitable pose estimation algorithm, e.g. to determine a model that directly estimates 3D pose given correspondences between 2D coordinates on the image plane and 3D coordinates in the object coordinate system. This means that robust estimation may preferably be applied also in cases where 2D position and 3D pose are not estimated separately.

2D estimation module 512 may use an iteration parameter N, for adjusting the maximum number of iterations spent in the sample consensus process. More iterations generally increase computation time and potentially increase the accuracy of the resulting 2D position estimate. Thus, when the system is optimized for object recognition, iteration parameter N is set at a lower value than when the system is optimized for pose estimation. In the recognition state RES or the combined object recognition/tracking state COMB (hereunder discussed in more detail), a low iteration parameter N allows for faster pose estimation while sacrificing some accuracy in determining the position estimation.

When optimizing for recognition, iteration parameter N may be set to a value between 20 and 50. Below 20 iterations not enough inliers may be found due to a suboptimal estimated model. Above 50 iterations processing times might be too long given current hardware capabilities. When optimizing for pose estimation, iteration parameter N may be set to a value selected in a range between 50 and 500.

2D estimation function 512 may additionally and/or alternatively use inlier parameter L for adjusting the minimum number of inliers for a particular test model required to proceed to 3D estimation module 514 as a successful test model. In general, requiring a higher minimum number of inliers for a test model to succeed increases the accuracy of the test model. A higher minimum number of inliers is also likely to require the iterative sample consensus method to execute more iterations in order to meet the requirement. Thus, when the system is optimized for fast object recognition, the iteration parameter N may be set at a lower value than when the system is optimized for pose estimation, such that less resources is devoted to pose estimation. In the recognition state RES or the combined (or hybrid) object recognition/tracking state COMB (hereunder discussed in more detail), the result allows for faster recognition while sacrificing some accuracy in determining the pose information.

2D estimation module 512 may additionally and/or alternatively use an inlier threshold parameter T_inlier for adjusting the threshold value used to test whether a corresponding feature pair is an inlier or an outlier to a test model. If T_inlier is adjusted such that a smaller error is required for a corresponding feature pair to be an inlier, it becomes more difficult to find a successful test model because it is more difficult to find enough inliers to terminate the iterative sample consensus method. As such, more computation time may be needed if T_inlier is adjusted to require a stricter error threshold. However, the resulting model may be more accurate if the inliers are closer to the test model due to the stricter error threshold.

Thus, when optimizing for object recognition, T_inlier may be adjusted such that the error threshold for testing corresponding features pair is less strict. As a result, the estimated model may fit more loosely than a model generated based on a stricter error threshold (less accuracy), but would reduce the computational time likely needed for the pose estimation process.

On the basis of the 2D homography matrix and the intrinsic camera parameters 3D estimation module 514 may determine pose information (also referred to as “pose parameters”). Pose information may be estimated using non-linear optimization e.g. Levenberg-Marquardt (LM) algorithm, Gauss-Newton algorithm, Powell's Dog Leg algorithm, etc. The resulting pose information may include 6 values: 3 rotation angles and 3 translation values. The pose information are then saved as output of pose estimation function 506.

In general, the above described function parameters may be used to configure the image processing function into a certain detection state. In particular, the state manager 518 may configure the image processing function on the basis of a first set of function parameters values defining a first detection state.

After having configured the image processing function, the state manager 518 may monitor the image processing function for certain state transition conditions. If such condition is met, the state manager 518 may initiate a transition to a second detection state, wherein the second detection state is determined by a second set of function parameters. A state transition may be effected by adjusting at least one of the parameter values in the first subset. The adjustment of parameters may be dependent on the number of detected targets. Similarly, the adjustment of parameters may be dependent on at least one of the following factors: the hardware specifications of the device, camera exposure, the frame rate, etc.

In a preferred embodiment, Keypoint parameter K may be adjusted from a first value associated with a first detection state to a second value associated with a second detection state In another embodiment, iteration parameter N may be adjusted from a first value associated with a first detection state to a second value associated with a second detection state.

One of the ways to render the three-dimensional transformed vector graphic (object) into the augmented reality view is to determine two types of matrices: 1) a model-view matrix and 2) a projection matrix. The model-view matrix contains information about the rotation and translation of the camera relative to the object (transformation parameters obtained from the tracker). On the other hand, because the three-dimensional virtual world is displayed in a two-dimensional display, the projection matrix specifies the projection of three-dimensional world coordinates to two-dimensional image coordinates. Both matrices may be specified as homogeneous 4×4 matrices, for instance, the same is used by the rendering framework based on the OpenGL framework. The projection matrix can alternatively be specified as a 3×4 matrix using homogeneous coordinates.

The projection matrix is calibrated initially to match the camera (digital imaging part) in the device by using the intrinsic camera parameters, i.e. the focal length of the lens and the resolution of the camera sensor, as input. The data from the camera may similarly be used for pose estimation in the tracker. The model-view matrix is updated in every frame to match the position of the augmentation with the position of the target object. The estimation on the position is updated by the tracker.

In one embodiment, this computation is a two-step process, utilizing in part the pose estimation function 506. First, the two-dimensional position of the projected target object is determined in the current image by matching the reference features with the extracted features and performing a robust iterative model fitting process as already described above in detail. The two-dimensional positions of the target object corners in the current image are mapped to the three-dimensional positions of the target object in three-dimensional space by the following projection function:

x=P*H*X

where X is a 4-dimensional vector representing the 3-dimensional object position vector in homogeneous coordinates. H is the 4×4 homogeneous transformation matrix, P is the 3×4 homogeneous camera projection matrix, and x is a 3-dimensional vector representing the 2-dimensional image position vector in homogenous coordinates.

The transformation matrix H is the output of the three-dimensional pose estimation step (e.g., underlying degrees of freedom associated with rotation and translation) that may be estimated using non-linear optimization. X may include the coordinates of a canonical object position before transformation (e.g. in the origin in a default orientation). x may include the respective projected coordinates of the object in the image place. These coordinates may be computed using the projective transformation (also referred to as “homography”) estimated in the a robust iterative estimation process for estimating the two-dimensional homography information.

The transformation matrix H represents the three rotation parameters and translation parameters by six degrees of freedom. The transformation matrix H, once generated, may be used to transform the augmented reality content such that the content can be displayed in perspective with the target object. The rotation and translation parameters may be estimated by a non-linear optimization procedure (Levenberg-Marquardt algorithm), or by any suitable algorithm that aims to solve the Perspective-n-Point problem. After this step, the matrix H can be used in the rendering routines for the augmented reality content or graphical overlay(s), such that the augmented reality content can be rendered and displayed in the display of the user device in perspective with the target object.

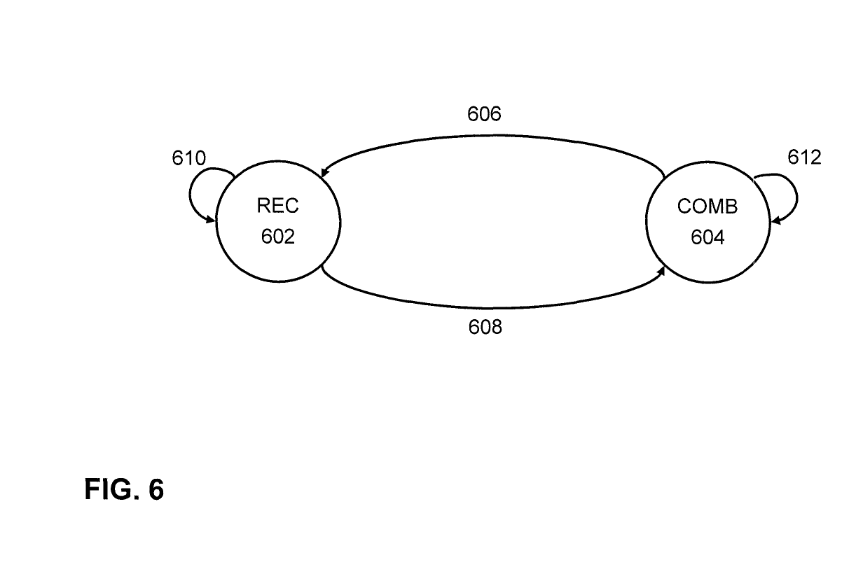

FIG. 6 depicts a state machine description of at least two detection states associated with the image processing function according to another embodiment of the invention. The state machine description may be used by the state manager in order to dynamically configure the image processing function depending on one or more predetermined conditions in a similar way as described with reference to FIGS. 2A, 2B and 3. In particular, FIG. 6 depicts a first detection state 602 (the recognition state REC) and a second detection state 604 (the combined recognition and tracking state COMB). In the recognition state 602, a state manager may configure the image processing function such that object recognition is optimized towards speed. The first detection state 602 is similar to the first detection state 230 in FIG. 2B.

In the combined recognition and tracking state 604, the state manager may configure the image processing function on the basis of function parameters such that detection of previously detected targets (i.e., in the previous image frame) is optimized towards accuracy and that the detection of all other targets is optimized towards speed.

For instance, a state manager may initialize the imaging process in the recognition state 602. If no object has been detected in the image frame, the detection state of the image processing function remains the recognition state 602 (denoted by arrow 610). If an object has been detected in the image frame, the state transition to the combined recognition and tracking state 604 (denoted by arrow 606) is initiated by the state manager.

The transition into the combined recognition and tracking state 604, is initiated by state manager using a predetermined set of function parameter values. If an object remains detected in the image frame, the state remains in the combined recognition and tracking state 604 (denoted by arrow 612). If no objects are detected in the image frame, then the state transitions back to the recognition state 602 (denoted by arrow 606).

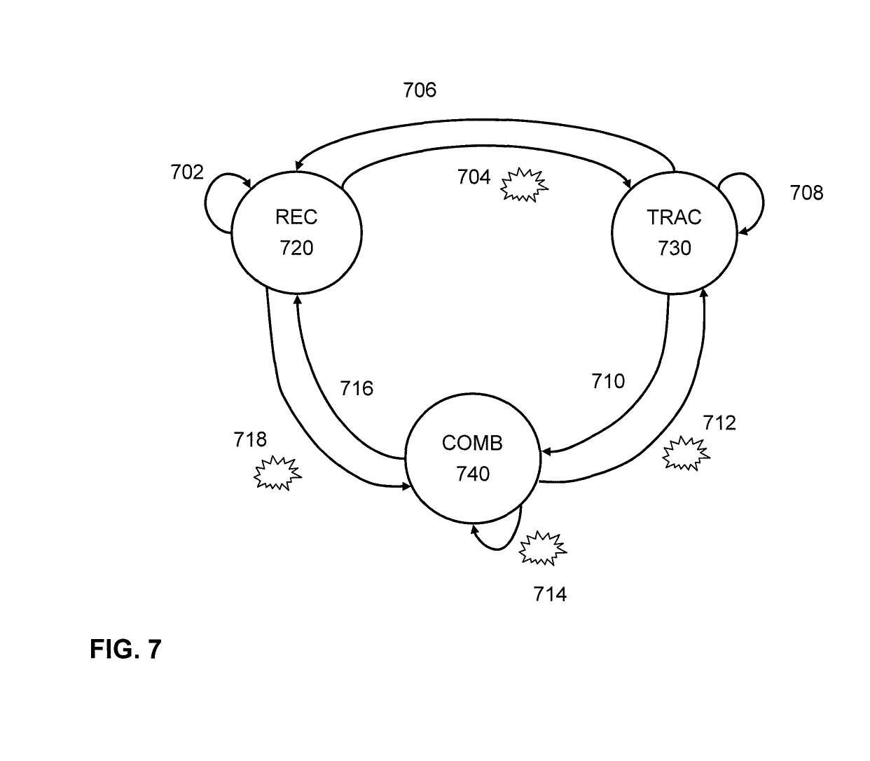

FIG. 7 depicts a state machine description of at least three detection states associated with the image processing function 202 according to another embodiment of the invention. In this particular embodiment, at least three different detection states of the image processing function 202 may be defined. In particular, FIG. 7 depicts a first detection state 720 (the recognition state REC), a second detection state 730 (the combined recognition state and tracking state COMB) and a third detection state 740 (the tracking state TRAC).

The state diagram in FIG. 7 illustrates possible state transitions between the three detection states. However, one skilled in the art would also understand that some transitions between the states may not be allowed depending on the circumstances. Each transition is associated with certain conditions and when those conditions are met the state manager may initiate a transition.

The recognition state (REC) 720 may be associated with one or more function parameters which are set to a value such that the detection of a target that is present in the image is likely to be successful in the least amount of time (i.e. optimized towards speed). Preferably, the system is able to detect all loaded targets (i.e., the feature matching state is performed for all loaded targets).

Tracking state (TRAC) 730 may be associated with one or more function parameters which are set to values such that detection of at least one target that is present in the image can be performed with high precision (i.e., optimized towards accuracy). Preferably, the system is able to detect previously detected targets (i.e., the feature matching stage is performed for all targets that were recognized in the preceding frame, from any state). In one embodiment, in the tracking state 730, function parameters may be set so that no other targets can be detected to save on processing time.

The hybrid recognition and tracking state (COMB) 740 may be associated with one or more function parameters which are set to values such that detection of previously detected targets in the previous frame is optimized toward accuracy and that the detection of all or at least some other targets are optimized toward speed. In one embodiment, in the combined tracking and recognition mode 740, function parameters may be set so that the image processing function is configured to detect all targets in an image frame.

States, transitions therein and conditions for such transitions as depicted in FIG. 7 are described in more detail in the box below (the following terms are use: REC—Recognition state; TRAC—Tracking state; COMB—Hybrid recognition and tracking state; f0—first/previous frame, f1—second/next frame):

REC->REC (transition 702): No targets detected in f0 in the REC state 720. Looking for all loaded targets in f1 in the REC state. No transition to anther detection state.
REC->TRAC (transition 704): One or more targets detected in f0 in the REC state 720. Looking for these detected targets in f1 in the TRAC state 730. No new targets need to be recognized.
REC->COMB (transition 718): One or more targets detected in f0 in the REC state 720. Looking for all loaded targets in f1 in the COMB state 740.
TRAC->REC (transition 706): No targets (from previous detections) detected in f0 in the TRAC state 730. Looking for all loaded targets in f1 in the REC state 720.
TRAC->TRAC (transition 708): One or more targets (from previous detections) detected in f0 in the TRAC state 730. Looking for these detected targets in f1 in the TRAC state 730. No new targets need to be recognized.
TRAC->COMB (transition 710): One or more targets (from previous detections) detected in f0 in the TRAC state 730. Looking for these detected targets in f1 in the COMB state 740. New targets should be recognized (e.g. because one of the previously recognized targets was lost.)
COMB->REC (transition 716): No targets detected in f0 in the COMB state 740. Looking for all loaded targets in f1 in the REC state 720.
COMB->TRAC (transition 712): One or more targets detected in f0 the COMB state 740. Looking for these detected targets in f1 in the TRAC state 730. No new targets need to be recognized.
COMB->COMB (transition 714): One or more targets detected in f0 in the COMB state 740. Looking for all loaded targets in f1 in the COMB state 740.

Hence, as shown by this example, specific detection states associated with specific image processing functions may be defined. A state manager allows dynamic switching between these states on the basis of certain conditions. This way, a scalable solution is provided for both fast and accurate detection of multiple objects in image frames as for example required in AR applications. The dynamically configurable image processing function may be used in AR application such that true AR user experience is achieved.

Exemplary parameter values associated with different detection states are shown below:

In recognition state REC 720, at least one or more of the following function parameters may be set to the following values:
RES=low,
MSC=false (no multiscale approach->decreased accuracy)
K=150 (fewer keypoints to be tested->decreased accuracy)
C=40 (need few correspondences to go further)
N=30 (allow for very low maximum of sample consensus iterations->decreased accuracy)
L=20 (require lower number of inliers for recognition->decreased accuracy)
Tinl=7.0 (allow larger error margin for inlier classification->decreased accuracy)
In tracking state TRAC 730, at least one or more of the following function parameters may be set to the following values:
RES=high, MSC=true
K=250 (more keypoints to be tested)
C=150 (need more correspondences to go further)
N=200 (allow for a larger maximum of sample consensus iterations)
L=40 (need a larger number of inlier data points)

### Tinl=5.0

In tracking/recognition state COMB 740, at least a number of the following function parameters may be set to the following values:
RES=high, MSC=true

### K=250

For targets detected in the previous frame:

### C=150

### N=200

### L=40

### Tinl=5.0

For all other targets:

### C=40

### N=30

### L=20

### Tinl=7.0

Values associated with some function parameters may be selected from a range. For example, in recognition state 720, Keypoint parameter K may be set to a value between 50 and 500, preferably 50 and 250, more preferably 50 and 150. Below 50, not enough inliers may be found due to an insufficient number of features. Above 150, processing times may be too long given current hardware capabilities, however when hardware capabilities are improving higher K values may be used. Similarly, iteration parameter N may be set to a value between 20 and 50. Below 20, not enough inliers may be found due to a suboptimal estimated model. Above 50, processing times might be too long given current hardware capabilities.

Furthermore, values of the parameters may be correlated. For example, C and L may be correlated with the values chosen for K and N. If more “candidate” keypoints (i.e. higher K) are processed for feature extraction, then more correspondences with the pre-loaded reference features are likely to be found. In general, the value for K would saturate at some point since the number of reference features extracted from a reference image is finite.

If the number of sample consensus iterations (parameter N) is increased, the estimated model is likely to be improved, i.e., it is likely to contain more inliers.

If parameter L is adjusted below L=20, an incorrect model estimation is more likely to be regarded as correct (false positive). Because L=20 implies faster speeds of recognition state, L=20 may be a lower bound. If parameter L is adjusted above L=approx. 40 or 50, a correct model estimation may be more likely to be regarded as incorrect (false negative). This L value may be a upper bound for the minimum number of inliers in tracking state to minimize the chance of false positives and to increase tracking stability.

In practice, only a small number of targets (e.g., 1-5 target(s)) are expected to be present in the image frame at the same time. Depending on the target(s) recognized in the previous frame, it may be preferable to not provide the ability (i.e., execute processes) to recognize more targets in the current frame. For example, if one target is allowed to be recognized at a time, the state may only switch from REC state 720 to TRAC state 730 and back. Other scenarios may allow for simultaneous recognition of more than one target. In those scenarios, a transition may occur from REC 720 to COMB state 740, and further transition from COMB 740 to TRAC state 730 in the event that a maximum number of recognized targets has been reached.

In some embodiments, the feedback output to the user is emitted, when suitable, at any of the transitions 704, 712, 714, and/or 718 (denoted by an explosion symbol). Examples of feedback output may include haptic feedback (e.g., vibration), visual feedback (e.g., showing augmented reality content associated with the detected object, a textual message, a graphic icon, a loading screen, etc.) and audio feedback (e.g., a beep, audio message, etc.). By emitting feedback, a user is notified that at least one object has been detected, when the user might otherwise not know the exact moment when a target object as been detected. The feedback may signal to the user that he/she should stop “scanning” around with the phone and should direct attention to the recognized target object.

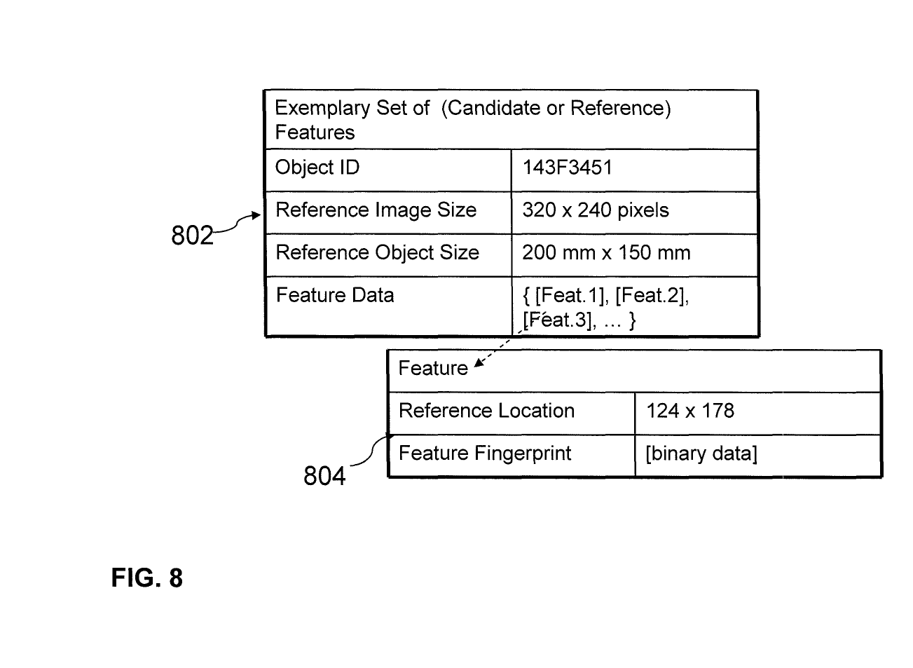

FIG. 8 depicts a data structure format associated with set of features, according to one embodiment of the invention. Data structure 802 shown may be suitable for managing candidate features as well as reference features. Server 102 of FIG. 1 may store reference features (e.g., a set of reference features for each target object) that enables image processing function 116 of FIG. 1 to recognize the target object and estimate the three-dimensional pose of a target object. Feature extraction module 204 of FIG. 2 may be configured to produce candidate features stored in data structure as illustrated in FIG. 8.

In general, a set of reference features is associated with each target object, and is preferably stored in a relational database, a file or the like. Data structure 802 includes an object ID for uniquely identifying the target object. Data structure 802, when used for a set of reference features associated with a target object, may include data for the reference image associated with the target object, such as data related to reference image size (e.g., in pixels) and/or reference object size (e.g., in mm).

Data structure 802 may include feature data or references to the feature data. Feature data may be stored in a list structure of a plurality of features. In some embodiments the features are sorted. Each feature, as seen in exemplary feature 804, may include information identifying the location of a particular feature in the image frame in pixels. Each feature may be associated with binary data that describes the feature.

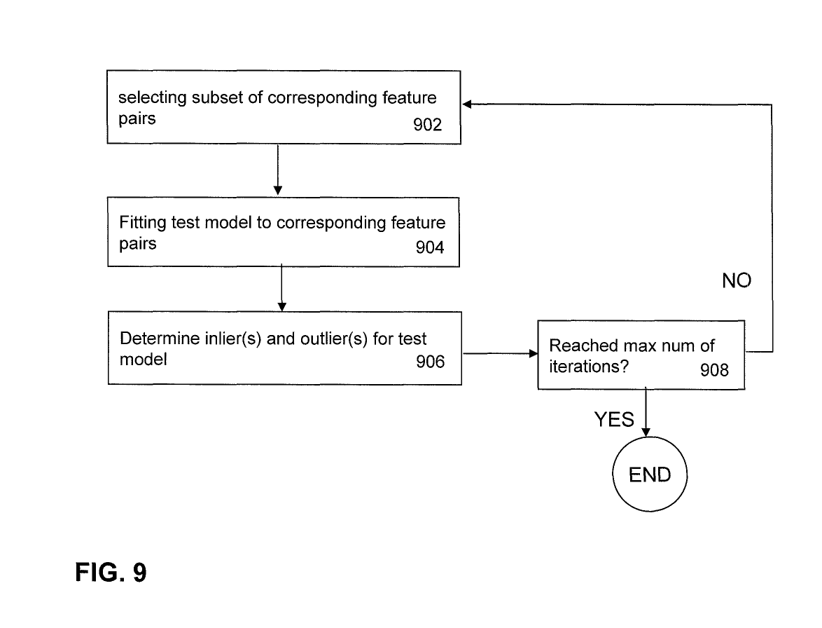

FIG. 9 shows an exemplary flow diagram, according to one embodiment of the invention. The flow diagram shown illustrates the subroutine used for the iterative sample consensus method implemented in 2D estimation module 512 of FIG. 5. At each iteration within the iterative sample consensus method, a subset of corresponding features (as determined by, e.g., feature matching module 206 of FIG. 2) is first selected (e.g., in reference to box 902) from the full set of corresponding features. The subset is used to form a test model for estimating the 2D homography matrix. The test model is fitted against the (full set of) corresponding features to determine whether the test model is sufficiently good (e.g., in reference to box 904). At each fitting, preferably corresponding features (not in the selected subset) are tested to determine the error or distance between (1) each of the corresponding features (not in the selected subject subset) and (2) the test model. The test may involve a threshold test to determine whether the particular corresponding feature is an inlier or an outlier (e.g., in reference to box 906). If the test model is better than all previously estimated test models, store parameters of this test model. The iterative method ends if a maximum number of iterations has been reached (e.g., in reference to box 908) and/or the test model has reach the minimum number of inliers to proceed for further processing (i.e., 3D pose estimation).

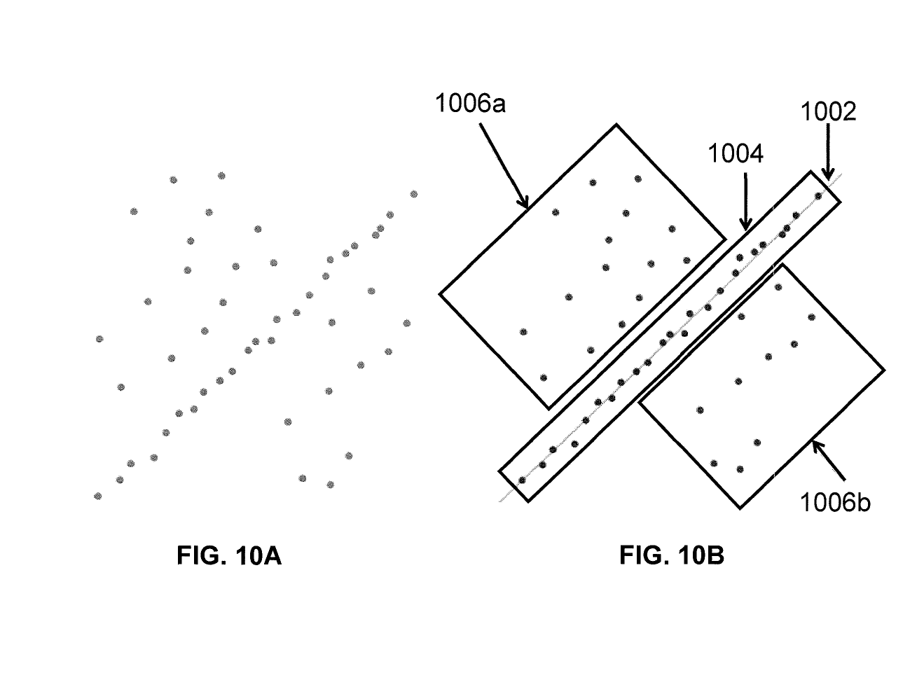

FIG. 10A-B illustrates the known iterative sample consensus algorithm RANSAC used for fitting a 2D homography model or a 3D pose model to a subset of candidate features at each iteration. To illustrate the concept, a simple example of fitting of a 2D line to a set of observations is shown (set of observations are seen in FIG. 10A). In FIG. 10B, the test model represented by line 1002, is fitted onto a subset of candidate features. The algorithm used for selecting the subset of candidate features may vary depending on the iterative consensus algorithm. Using an error threshold (e.g., distance of the candidate feature from the test model), candidate features may be categorized to be either an inlier (e.g., points in box 1004) or an outlier (e.g., points in box 1006a,b).

Inliers are points which approximately can be fitted to the test model. Outliers are points which cannot be fitted to this line. For instance, a simple least squares method for line fitting may produce a test model with a bad fit to the inliers (due to effects caused by the outliers). An iterative consensus method, on the other hand, is suitable for producing a test model which is only computed from the inliers, provided that the probability of choosing only inliers in the selection of data is sufficiently high.

With some modifications, one skilled in the art may extend the embodiments described herein to other architectures, networks, or technologies.

One embodiment of the disclosure may be implemented as a program product for use with a computer system. The program(s) of the program product define functions of the embodiments (including the methods described herein) and can be contained on a variety of computer-readable storage media. The computer-readable storage media can be a non-transitory storage medium. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory, flash memory) on which alterable information is stored.

It is to be understood that any feature described in relation to any one embodiment may be used alone, or in combination with other features described, and may also be used in combination with one or more features of any other of the embodiments, or any combination of any other of the embodiments. Moreover, the invention is not limited to the embodiments described above, which may be varied within the scope of the accompanying claims.

1. A method for dynamically configuring an image processing function into at least a first and second detection state on the basis of function parameters, wherein transitions between said first and second detection states are determined by at least a first state transition condition and wherein said image processing function includes extracting features from an image frame, matching extracted features with reference features associated with one or more target objects and estimating pose information on the basis of matched features, said method comprising:
configuring said image processing function in a first detection state on the basis of a first set of function parameter values;
processing a first image frame in said first detection state;
monitoring said image processing function for occurrence of said at least first state transition condition; and,
if said at least one state transition condition is met, configuring said image processing function in said second detection state on the basis of a second set of function parameter values for processing a second image frame in said second detection state.

2. The method according to claim 1 wherein said at least first state transition condition is: the detection of at least one target object in said first image frame, the detection of a predetermined number of objects in said first image frame, the absence in said first image frame of at least one previously recognized target object; and/or, the generation of pose information according to a predetermined accuracy and/or within a certain processing time.

3. The method according to claim 1 wherein said first detection state is determined by a first set of function parameter values so that said image processing function is configured for fast detection one or more objects in said first image frame.

4. The method according to claim 1 wherein said second detection state is determined by a second set of function parameter values so that the image processing function is configured for accurate determination of pose information of at least one object in a second image frame, said object previously being detected by said image processing function in said first detection state.

5. The method according to claim 1 wherein said second detection state is determined by a second set of function parameter values so that the image processing function is configured for accurate determination of pose information of at least one object in a second image frame, said at least one object previously being detected in said first image frame by said image processing function in said first detection state; and, for fast detection of one or more objects in said second frame that were not previously detected in said first image frame by said image processing function in said first detection state.

6. The method according to claim 1, wherein said first and second set of parameter values are configured such that in the first detection mode a smaller number of extracted features is used than in the second detection mode.

7. The method according to claim 1, wherein said first and second set of parameter values are configured such that in the first detection mode image frames of a lower resolution are used than the image frames used in the second detection mode.

8. The method according to claim 1, wherein said first and second set of parameter values are configured such that in the first detection mode the maximum computation time and/or the (maximum) number of iterations for pose estimation is smaller than the computation time and/or (maximum) number of iterations spent on pose estimation in the second detection mode.

9. The method according to claim 1, wherein said first and second set of parameter values are configured such that in the first detection mode a larger error margin and/or lower number of inlier data points for pose estimation is used than the error margin and/or number of inlier data points for pose estimation in said second detection mode.

10. The method according to claim 1, wherein said image processing function is configurable in a further third state, wherein transitions between said first and third detection states are determined by at least a second transition condition, said method further comprising:
monitoring said image processing function for occurrence of said at least second transition condition; and,
if said at least second state transition condition is met, configuring said image processing function in said third detection state on the basis of said third set of function parameter values for processing a second image frame in said second detection state.

11. The method, according to claim 1, wherein said processing of said first and second image frames further comprises:
providing sets of reference features, each set being associated with a target object;
determining corresponding features pairs by matching said extracted features with said reference features;
determining the detection of said target object on the basis of said corresponding features.

12. The method according to claim 1, wherein image processing function is part of an augmented reality device comprising an image sensor for generating image frames and a graphics generator for generating a graphical item associated with at least one detected target object on the basis of pose information.

13. The method according to claim 1, wherein a state manager is configured to configure said image processing function into at least said first or second detection state and to monitor said first state transition conditions, wherein function parameters values associated with said detection states and information associated with said first state transition condition is stored in a memory.

14. The method according to claim 1 wherein function parameters include parameters for determining and/or controlling: the number of features to be extracted from an image, the number or maximum number of iterations and/or processing time for processing features, at least one threshold value for deciding whether or not a certain condition in said image processing function is met, the resolution an image is to be processed in by said image processing function.

15. A dynamically configurable image processing module comprising:
a processor configured to execute a processing function configurable into at least a first and second detection state on the basis of function parameters, wherein said image processing function includes extracting features from an image frame, matching extracted features with reference features associated with one or more target objects and estimating pose information on the basis of matched features;
a state manager operably connected to and configured to configure said image processing function in one of detection states and configured to manage transitions between said detection states on the basis of least a first state transition condition, said state manager being configured to:
configure said image processing function in a first detection state on the basis of a first set of function parameter values for processing a first image frame;
monitor said image processing function for occurrence of said at least first state transition condition; and, if said at least one state transition condition is met; and,
configure said image processing function in said second detection state on the basis of a second set of function parameter values for processing a second image frame in said second detection state.

16. An augmented reality device comprising:
image sensor configured to generate image frames;
a dynamically configurable image processing module connected to the image sensor and configured to detect one or more target objects in an image frame and configured to generate pose information associated with at least one detected object the dynamically configurable image processing module:
a processor configured to execute a processing function configurable into at least a first and second detection state on the basis of function parameters, wherein said image processing function includes extracting features from an image frame, matching extracted features with reference features associated with one or more target objects and estimating pose information on the basis of matched features;
a state manager configured to configure said image processing function in one of detection states and configured to manage transitions between said detection states on the basis of least a first state transition condition, said state manager being configured to:
configure said image processing function in a first detection state on the basis of a first set of function parameter values for processing a first image frame;
monitor said image processing function for occurrence of said at least first state transition condition; and, if said at least one state transition condition is met; and,
configure said image processing function in said second detection state on the basis of a second set of function parameter values for processing a second image frame in said second detection state
a graphics generator connected to the dynamically configurable image processing module and configured to generate a graphical item associated with said detected object on the basis of said pose information.

17. An augmented reality system comprising:
a feature database comprising reference features associated with one or more target objects, said one or more target objects being identified by object identifiers;
a content database comprising one or more content items associated with said target objects, said one or more content items being stored together with one or more object identifiers;
at least one augmented reality device, wherein said augmented reality device is connected to said feature database and configured to:
retrieve reference features from said feature database on the basis of one or more object identifiers; and,
retrieve one or more content items associated with one or more objects on the basis of said object identifiers.

18. The augmented reality device according to claim 16, further comprising a communication module configured to access said content database and/or said feature database via a data communication network.

19. A computer program product, implemented on computer-readable non-transitory storage medium, the computer program product configured for, when run on a computer, executing a method for dynamically configuring an image processing function into at least a first and second detection state on the basis of function parameters, wherein transitions between said first and second detection states are determined by at least a first state transition condition and wherein said image processing function includes extracting features from an image frame, matching extracted features with reference features associated with one or more target objects and estimating pose information on the basis of matched features, said method comprising:
configuring said image processing function in a first detection state on the basis of a first set of function parameter values;
processing a first image frame in said first detection state;
monitoring said image processing function for occurrence of said at least first state transition condition; and,
if said at least one state transition condition is met, configuring said image processing function in said second detection state on the basis of a second set of function parameter values for processing a second image frame in said second detection state.

20. The method according to claim 7, said lower resolution images being a downscaled version of one or more images originating from an image sensor.
